(19) United States
(12) Patent Application Publication
(10) Pub. No.: US 2020/0180133 A1
(43) Pub. Date: Jun. 11, 2020

(54) OSCILLATING TOOL WITH MULTIPLE OSCILLATING ANGLES

(71) Applicant: TTI (MACAO COMMERCIAL OFFSHORE) LIMITED, Macau (MO)

(72) Inventors: Wai Tong CHAN, Tsing Yi (HK); Kwok Ting MOK, Tokwawan (HK)

(21) Appl. No.: 16/467,311

(22) PCT Filed: Jan. 10, 2017
(86) PCT No.: PCT/CN2017/070751

§ 371 Date: Jun. 6, 2019

(51) Int. Cl. B25F 5/00; B25F 5/02

(52) U.S. Cl. CPC B25F 5/001; B25F 3/00; B25F 5/02

(57) ABSTRACT

An oscillating power tool (10) including a main body (14) housing a motor (22) and a drive mechanism (58) operatively coupled to the motor (22). The drive mechanism (58) includes a shaft (66) that is selectively driven in a first rotational direction (194) and in a second rotational direction (206) opposite to the first rotational direction (194). The oscillating power tool (10) further includes an output mechanism (60) operatively coupled to the drive mechanism (58), and the drive mechanism (58) converts rotation of the shaft (66) into oscillation of the output mechanism (60). The drive mechanism (58) is operatively coupled to drive the output mechanism (60) to provide a first degree of oscillation when the shaft (66) is driven in the first rotational direction (194) and operatively coupled to drive the output mechanism (60) to provide a second degree of oscillation when the shaft (66) is driven in the second rotational direction (206), the second degree of oscillation different from the first degree of oscillation.

### BACKGROUND

The present disclosure relates to power tools driven by an electric motor, and more specifically, the present invention relates to oscillating power tools. Power tools utilize the rotation of an electric motor to provide useful torque for operations such as cutting.

### SUMMARY

In one construction, the disclosure provides an oscillating power tool including a main body housing a motor. The oscillating power tool further includes a drive mechanism operatively coupled to the motor. The drive mechanism includes a shaft that is selectively driven in a first rotational direction and in a second rotational direction opposite the first rotational direction. The oscillating power tool further includes an output mechanism operatively coupled to the drive mechanism. The drive mechanism converts rotation of the shaft into oscillation of the output mechanism. The drive mechanism is operatively coupled to drive the output mechanism to provide a first degree of oscillation when the shaft is driven in the first rotational direction and operatively coupled to drive the output mechanism to provide a second degree of oscillation when the shaft is driven in the second rotational direction, the second degree of oscillation different from the first degree of oscillation.

In another construction, the oscillating power tool includes a main body housing a motor. The oscillating power tool further includes a drive mechanism having a main shaft rotatable about a first axis and selectively rotatable in a first rotational direction and in a second rotational direction. An output mechanism is operatively coupled to the drive mechanism. The output mechanism is configured to oscillate. The drive mechanism converts rotation of the main shaft into oscillation of the output mechanism. The drive mechanism includes an eccentric member defining a second axis parallel to and offset from the first axis. The eccentric member is movable with respect to the main shaft between a first position having a first offset distance between the second axis and the first axis and a second position having a second offset distance between the second axis and the first axis, wherein the first offset distance is different from the second offset distance. The first offset distance corresponds to a first degree of oscillation of the output mechanism and the second offset distance corresponds to a second degree of oscillation of the output mechanism. The first degree of oscillation is different from the second degree of oscillation.

In yet another construction, the disclosure provides a method of changing the degree of oscillation of an output shaft in a power tool having a motor and a drive mechanism configured to convert rotation of the motor into oscillation of the output shaft. The drive mechanism includes a fork for transferring motion from the drive mechanism to the output shaft and a main shaft configured to rotate about a first axis in a first direction and to rotate in a second direction opposite the first direction. The method includes providing an eccentric member operatively coupled to the main shaft and to the forked member and having a variable eccentricity to effectuate a change in the degree of oscillation of the output shaft of the power tool.

Other aspects of the disclosure will become apparent by consideration of the detailed description and accompanying drawings.

### BRIEF DESCRIPTION OF THE DRAWINGS

FIG. 1 is a side view of a power tool having a head and a handle according to one construction of the invention.

FIG. 2 is a cross section of the head of FIG. 1 taken along line 2-2.

FIG. 3 is a perspective view of a drive mechanism portion of the power tool shown in FIG. 1.

FIG. 4 is an exploded view of a main shaft and a shaft tip of the drive mechanism of FIG. 3.

FIG. 5 is a perspective view of the main shaft and the shaft tip of FIG. 4.

FIG. 6 is a section view of the main shaft of FIG. 4 taken along line 6-6.

FIG. 7 is a perspective view of the shaft tip of FIG. 4.

FIG. 8 is a front view of the main shaft and the shaft tip of FIG. 5 when a motor of the power tool is rotating in a first direction.

FIG. 9 is a section view of the main shaft and the shaft tip of FIG. 5 taken along the line 9-9.

FIG. 10 is a front view of the main shaft and the shaft tip of FIG. 5 when a motor of the power tool is rotating in a second direction.

FIG. 11 is section view of the main shaft and the shaft tip of FIG. 5 taken along the line 11-11.

Before any embodiments or constructions of the disclosure are explained in detail, it is to be understood that the disclosure is not limited in its application to the details of construction and the arrangement of components set forth in the following description or illustrated in the following drawings. The disclosure is capable of other embodiments and constructions and of being practiced or of being carried out in various ways. Also, it should be understood that the phraseology and terminology used herein are for the purpose of description and should not be regarded as limiting.

### DETAILED DESCRIPTION

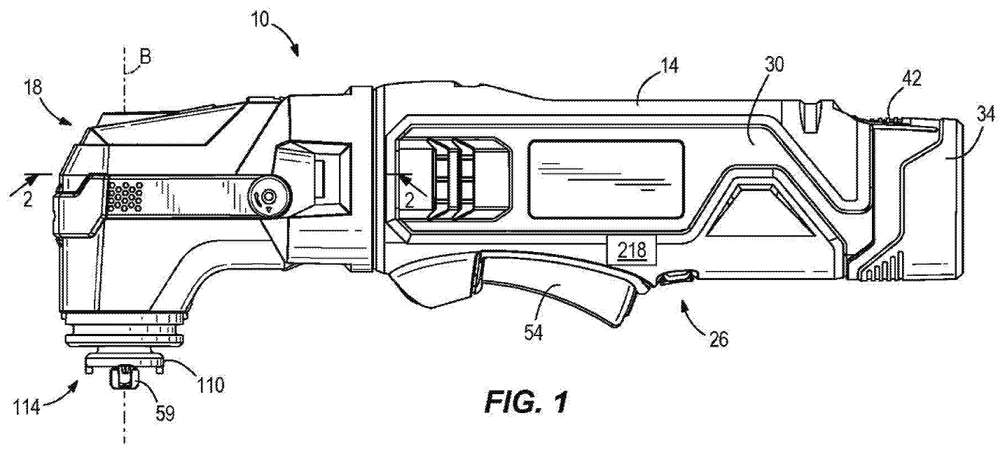

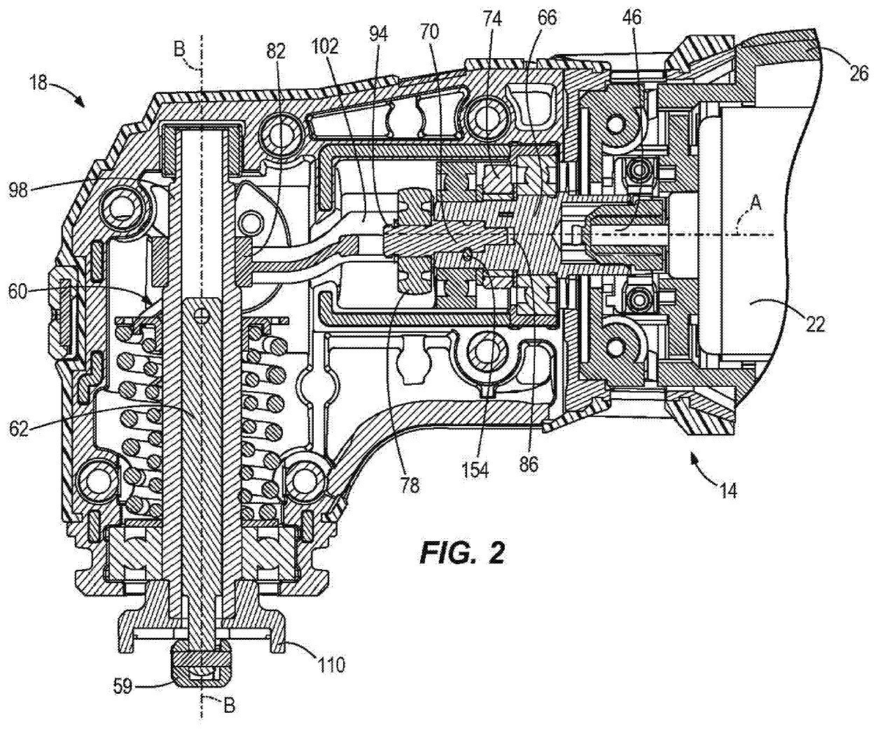

FIGS. 1-3 illustrate a power tool 10 according to one construction of the invention. The power tool 10 includes a handle 14, or main body, and a head 18 coupled to the handle 14 that is driven by a motor 22 (FIG. 2) housed within the handle 14. In the illustrated construction, the head 18 is selectively attachable to and detachable from the handle 14; however, in other constructions, the power tool 10 may be a unitary power tool and “head” and “handle” may refer generally to the head portion and the handle portion, respectively, of the unitary power tool.

The head 18 is an oscillating head and the motor 22 in the illustrated construction is 12V-DC, 2.0 Amps no load current. The motor 22 includes a motor drive shaft 46 and is either a reversible/bidirectional motor, as shown in the illustrated construction, or in other constructions may be a single-direction motor engaged with a reversing drive (not shown) for selectively reversing the direction of rotation of the motor drive shaft 46. For example, the reversing drive (not shown) may include a reversing mechanism driven by the motor drive shaft 46 and an intermediate shaft driven by the reversing mechanism in a direction opposite the direction of the motor drive shaft 46. In other constructions, other suitable motors may be employed, such as an alternating current (AC) motor, a pneumatic motor, etc. In yet other constructions, a variable speed or multi-speed motor may be employed.

The handle 14 includes a housing 26 and a grip portion 30 providing a surface suitable for grasping by a user to operate the power tool 10. The housing 26 generally encloses the motor 22, which has a motor drive shaft 46 extending therefrom. A longitudinal axis A (FIG. 2) is defined by motor 22 and the motor drive shaft 46.

The power tool 10 includes a removable and rechargeable battery pack 34. In the illustrated construction, the battery pack 34 is a 12-volt battery pack and includes three (3) Lithium-ion battery cells. In other constructions, the battery pack may include fewer or more battery cells such that the battery pack is a 14.4-volt battery pack, an 18-volt battery pack, etc., or the like. Additionally or alternatively, the battery cells may have chemistries other than Lithium-ion such as, for example, Nickel Cadmium, Nickel Metal-Hydride, or the like. In other constructions, other suitable batteries and battery packs may be employed. In yet other constructions, the power tool 10 may include a power cord so that it may be powered by a remote source of power, such as a utility source of AC connected to the cord. In yet other constructions, the power tool 10 may be pneumatically powered or powered by any other suitable source.

The handle 14 also includes an actuator 54 (FIG. 1). The actuator 54 is coupled with the housing 26 and is actuatable to power the motor 22, e.g., to electrically couple the battery pack 34 and the motor 22 to run the motor 22. The actuator 54 may be a trigger-style actuator (as shown), a sliding actuator, a button, etc., or the like.

The head 18 includes a drive mechanism 58 for converting rotary motion of the motor drive shaft 46 into oscillating motion of an output mechanism 60. As shown in FIG. 2, the output mechanism 60 includes a hollow spindle 98 having an arbor 110 disposed at a distal end thereof, and a clamping shaft 62 disposed slidingly within the hollow spindle 98. The arbor 110 is configured to receive a blade or accessory, as will be described in greater detail below, and the clamping shaft 62 includes a clamping member 59 at a distal end thereof for clamping the blade or accessory to the arbor 110. The hollow spindle 98 and/or the clamping shaft 62 define a longitudinal axis B (e.g., an oscillation axis) substantially perpendicular to the axis A. As shown in FIG. 2, the drive mechanism 58 includes a main shaft 66, an eccentric member 70, a counter balance 74, a ball bearing eccentric member 78, and a forked member 82.

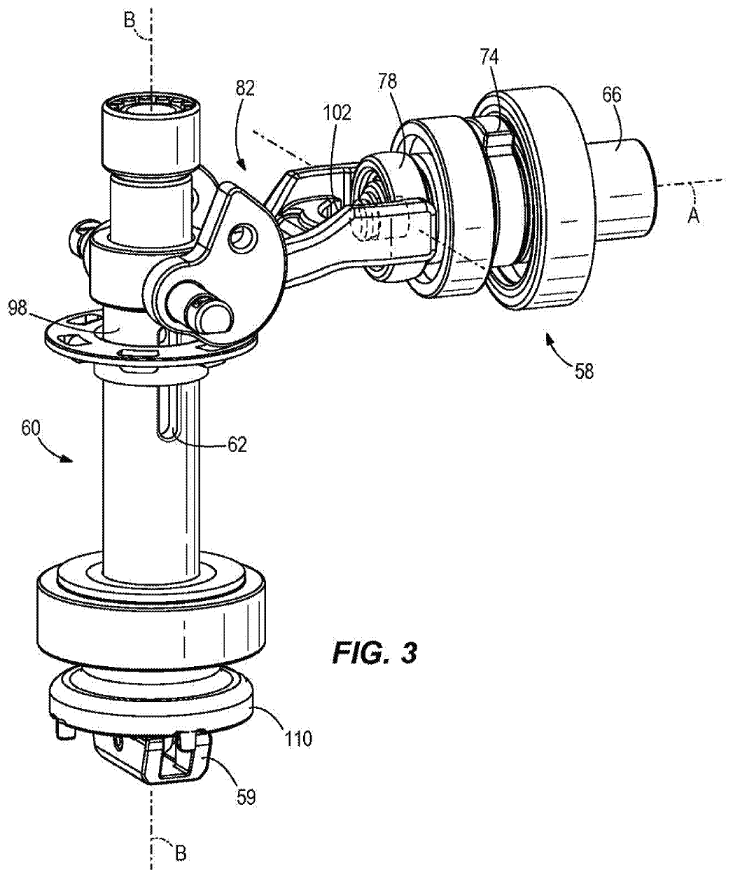

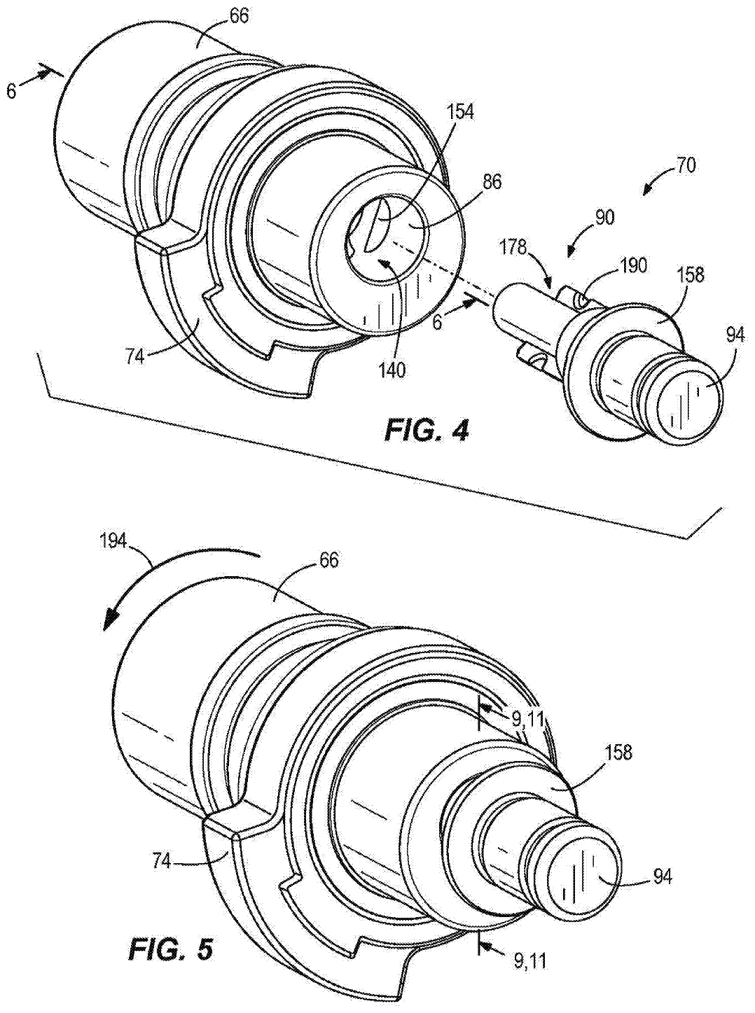

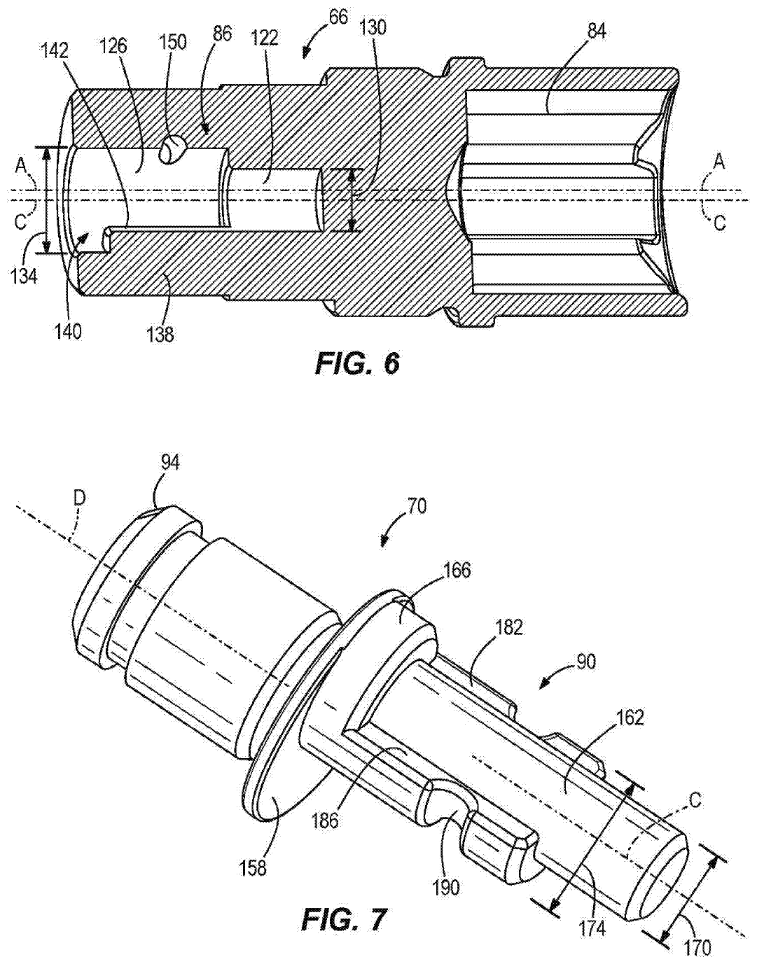

FIG. 3 illustrates the drive mechanism 58 and the output mechanism 60 in isolation, with the remainder of the power tool 10 removed from view. The main shaft 66 is aligned coaxially with the axis A and includes an eccentric bore 86 (FIG. 6) that is not centered about the axis A. Rather, the eccentric bore 86 defines an axis C that is parallel to and spaced or offset from the axis A, as shown in FIG. 6. A portion of the eccentric member 70 is received within the eccentric bore 86 of the main shaft 66, as is shown in FIG. 4 and will be described in greater detail below. The counter balance 74 is press fit on the main shaft 66, and the ball bearing eccentric member 78 is press fit on the shaft tip 94. The counter balance 74 counters the off-center rotation of the eccentric member 70 and the ball bearing eccentric member 78 to reduce vibrations caused by the eccentric rotation thereof.

The forked member 82 is coupled to the clamping shaft 62 by a sleeve 98 and includes two arms 102. The arms 102 are positioned adjacent generally opposite sides of the ball bearing eccentric member 78, and each arm 102 includes a contact portion 106 that engages an outer circumferential surface of the ball bearing eccentric member 78. As the ball bearing eccentric member 78 rotates and wobbles about the axis A, the ball bearing eccentric member 78 pushes each contact portion 106 in an alternating fashion to cause the forked member 82 to oscillate. Thus, the forked member 82 wobbles and oscillates about the axis B to convert the eccentric rotary motion of the ball bearing eccentric member 78 about the axis A into oscillating motion of the hollow spindle 98 about the axis B.

As shown in FIG. 2, the hollow spindle 98 terminates, at a free end, with the arbor 110. The arbor 110 includes a locating feature (not shown), such as a protrusion, sized and shaped for receiving a cutting accessory, such as a blade having an opening configured to mate with the locating feature. The arbor 110 cooperates with a clamping mechanism, such as the clamping shaft 59 for clamping the cutting accessory to the hollow spindle 98 for oscillating motion therewith.

With reference to FIG. 6, the main shaft 66 includes a motor engagement bore 84 and the eccentric bore 86 positioned at opposing ends of the main shaft 66. The motor engagement bore 84 extends along and is centered with respect to the axis A. The motor engagement bore 84 receives the motor drive shaft 46 so that the main shaft 66 rotates with the motor drive shaft 46. The eccentric bore 86 extends along the longitudinal axis C and includes a first portion 122, and a second portion 126. The first portion 122 has a first diameter 130 and is centered about the longitudinal axis C. The second portion 126 is positioned outward of the first portion 122 and has a second diameter 134 larger than the first diameter 130. The second portion 126 is centered about the axis C. The second portion 126 includes a protrusion 138 (also shown in cross section in FIGS. 9 and 11) that extends inwardly along a portion of a perimeter of the second portion 126 and protrudes into the eccentric bore 86. The protrusion 138 extends between a first driving surface 142 and a second driving surface 146, as shown in FIGS. 9 and 11, and is spaced inwardly of an opening 140 of the eccentric bore 86. In the illustrated construction, the protrusion 138 defines a wall of the first portion 122 of the eccentric bore 86. The protrusion 138 has a length that is shorter than a perimeter of the second portion 126. In the illustrated embodiment, the protrusion 138 has a length that is shorter than half of the perimeter of the second portion 126. The second portion 126 includes a through opening 150 that is substantially perpendicular to the axis C. The through opening 150 is sized to receive a pin 154.

As shown in FIG. 7, the eccentric member 70 includes a shaft post 90, a connection portion 158, and the shaft tip 94. The shaft post 90 is centered with respect to the axis C and the shaft tip 94 defines an axis D. The axis C and the axis D are parallel to the axis A. The shaft post 90 and the connection portion 158 are centered with respect to the axis C and are eccentric with respect to the axis A. The shaft tip 94 is centered with respect to the axis D, and eccentric with respect to the axis C and the axis A. Therefore, the shaft tip 94 is eccentric with respect to shaft post 90 and the connection portion 158.

With continued reference to FIG. 7, the shaft post 90 includes a first shaft post 162, and a second shaft post 166. The first shaft post 162 has a first diameter 170. The first shaft post 162 is centered about the axis C and spaced from the axis A. The second shaft post 166 has a second diameter 174 larger than the first diameter 170. The second shaft post 166 is positioned proximate and spaced from the connection portion 158. The second shaft post 166 includes a cutout 178 (FIG. 4) that extends between a first driven surface 182 and a second driven surface 186. The cutout 178 has a perimeter that is shorter than a perimeter of the second shaft post 166.

With reference to FIG. 2, the shaft post 90 is sized to be received by the eccentric bore of the main shaft 43. When the eccentric member 70 is positioned within the eccentric bore 86, the shaft tip 94 is eccentric with respect to the axis A. The second shaft post 166 is positioned within the second portion 126 of the eccentric bore 86 of the main shaft 66 so that the first driven surface 182 and the second driven surface 186 may engage the first driving surface 142 and the second driving surface 146, respectively. A combined perimeter of the protrusion 138 of the eccentric member 70 and the cutout 178 of the eccentric bore 86 is smaller than a perimeter of the eccentric bore 86 so that the eccentric member 70 is rotatable within the eccentric bore 86. A track 190 sized to receive the pin 154 extends along a perimeter of the inwardly extending cutout 178. As shown in FIG. 2, when the pin 154 is engaged with the track 190 and passes through the opening 150 of the main shaft 66, the pin 154 restricts movement of the eccentric member 70 along the axis C while allowing the eccentric member 70 to rotate freely about the axis C.

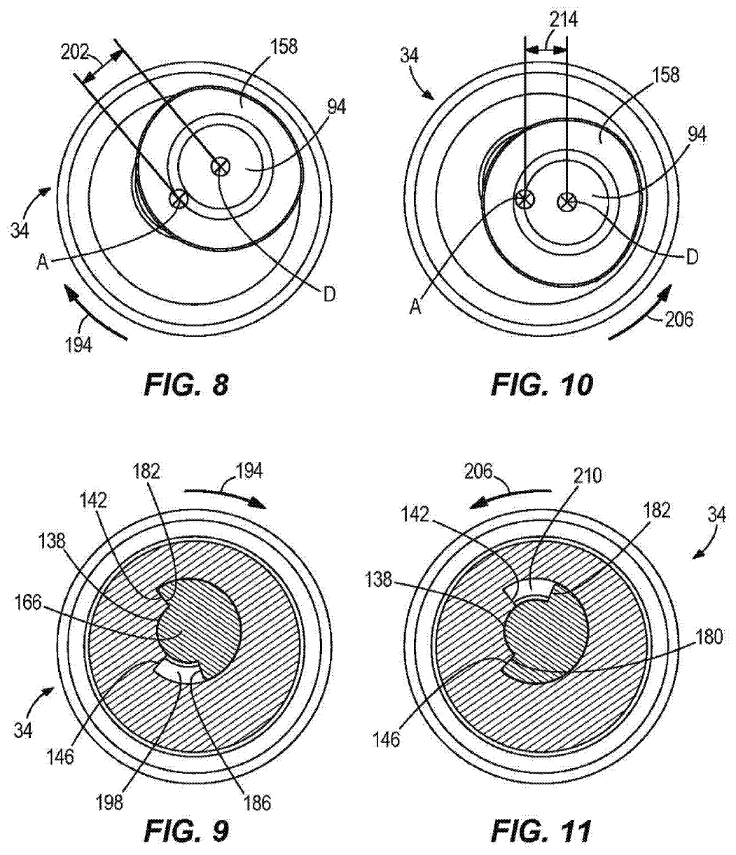

FIG. 9 shows a cross-section of the second portion 126 of the main shaft 66 and the second shaft post 90 of the eccentric member 70 when the motor drive shaft 46 is rotating in a direction shown by an arrow 194, which may correspond to reverse rotation of the motor drive shaft 46. Rotation of the main shaft 66 causes the first driving surface 142 of the main shaft 66 to engage the first driven surface 182 of the eccentric member 70 so that the shaft tip 94 of the eccentric member 70 rotates away from the axis A. A gap 210 is formed between the second driving surface 146 and the second driven surface 186 when the first driving surface 142 is engaged with the first driven surface 182. As shown in FIG. 8, a center 212 of the shaft tip 94 is spaced a first eccentric offset distance 202 from the axis A. The first eccentric offset distance 202 causes the clamping shaft 62 to oscillate in a first degree of oscillation. In the illustrated construction, the first eccentric offset distance 202 is approximately 1.97 mm and corresponds to approximately 6 degrees of oscillation of the clamping shaft 62.

FIG. 11 shows a cross-section of the second portion 126 of the main shaft 66 and the second shaft post 166 of the eccentric member 70 when the motor drive shaft 46 is rotating in a direction shown by an arrow 206, which may correspond to forward rotation of the motor drive shaft 46. Rotation of the main shaft 66 causes the second driving surface 146 of the main shaft 66 to engage the second driven surface 186 of the eccentric member 70 so that the shaft tip 94 of the eccentric member 70 rotates toward the axis A. A gap 198 is formed between the first driving surface 142 and the first driven surface 182 when the second driving surface 146 is engaged with the first driven surface 186. As shown in FIG. 10, the center 212 of the eccentric member 70 is spaced a second eccentric offset distance 214 from the axis A. The second eccentric offset distance 214 causes the clamping shaft 62 to oscillate in a second degree of oscillation. In the illustrated construction, the second eccentric offset distance 214 is approximately 1.11 mm and corresponds to approximately 4 degrees of oscillation of the clamping shaft 62.

In the illustrated construction, the first eccentric offset distance 202 is larger than the second eccentric offset distance 214, meaning that the first degree of oscillation is larger than the second degree of oscillation. In the illustrated construction, the larger degree of oscillation occurs when the motor is operating in the reverse direction and the smaller degree of oscillation occurs when the motor is operating in the forward direction. In other constructions, the first eccentric distance 202 may be smaller than the second eccentric distance 214. Accordingly, the larger degree of oscillation may occur when the motor operates in the forward direction and the smaller degree of oscillation may occur when the motor is operating in the reverse direction. In alternate constructions, the size of the first offset distance and the second offset distance may be varied (e.g., by altering the dimensions of the protrusion 138 of the eccentric bore 86 and the cutout 178 of the eccentric member 70) to effectuate other degrees of oscillation as desired.

As discussed above, the ball bearing eccentric member 78 is secured to the shaft tip 94. As the eccentric member 70 is rotated by the main shaft 66, the ball bearing eccentric member 78 wobbles about the axis A. The eccentric member 78 pushes each contact portion 106 of the forked member 82 in an alternating fashion to cause the forked member 82 to reciprocate. The forked member 82 reciprocates about the axis B and, in turn, transfers oscillating motion to the hollow spindle 98. When a center 92 of the shaft tip 94 is relatively far from the axis A (e.g., for relatively large eccentric distances), the ball bearing eccentric member 78 wobbles more than it does when the shaft tip 94 is relatively close to the axis A. A greater amount of wobble of the ball bearing eccentric member 78 corresponds to a greater degree of oscillation of the hollow spindle 98 about the axis B. Accordingly, an operator may change the degree of oscillation of the power tool 10 by changing the operating direction of the motor 22 or, alternatively, by engaging the reversing drive (not shown) to convert the rotation of the motor drive shaft 46 into rotation of the intermediate shaft (not shown) in an opposite direction of the motor drive shaft 46.

The oscillating tool 10 includes a switch 218 (FIG. 1) configured to change the degree of oscillation between the first degree of oscillation and the second degree of oscillation. The switch 218 may be integrated with the actuator 54 or separate from the actuator 54. As shown in FIG. 1, the switch 218 may be a separate switch movable between two positions (by rotating, sliding, pushing, etc.). A first position of the switch designates a first direction of rotation of the main shaft 66 (e.g., clockwise) and a second position designates a second degree of rotation (e.g., an opposite direction, such as counterclockwise). Then, when the operator actuates the actuator 54, the main shaft 66 rotates in the direction corresponding to the position of the switch 218 and the output mechanism 60 oscillates at the angle corresponding with the direction of rotation of the main shaft 66. In other constructions, the switch could be integrated with the actuator 54. For example, the actuator 54 may be movable between a first position corresponding to the first oscillation angle, and a second position corresponding to the second oscillation angle, and a third position corresponding to the motor off.

In operation, an operator actuates the switch 218 to select a larger degree of oscillation or a smaller degree of oscillation. The user then depresses the switch trigger 54 to engage the motor 22. If the operator has chosen the larger degree of oscillation, the motor 22 is actuated in the direction corresponding to the larger eccentric distance. If the operator has chosen the smaller degree of oscillation, the motor 22 is actuated in the direction corresponding to the smaller eccentric distance.

For example, in the illustrated construction, if the operator selects the larger degree of oscillation, the motor 22 operates in the first direction 194. The main shaft 66 rotates about the axis A in the first direction 194. Rotation of the main shaft 66 in the first direction 194 causes the first driving surface 142 of the eccentric bore 86 of the main shaft 66 to engage the first driven surface 182 of the eccentric member 70. Once the first driving surface 142 of the main shaft 66 is engaged with the first driven surface 182 of the eccentric member 70, the center 212 of the tip 94 of the eccentric member 70 is spaced the first eccentric distance 202 from the axis A. The ball bearing eccentric member 78 engaged with the tip 94 of the eccentric member 70 will push the arms 102 of the forked member 82 a first amount corresponding to the first eccentric distance 202, causing the clamping shaft 62 shaft to oscillate with the first degree of oscillation.

If the operator selects the smaller degree of oscillation, the motor operates in the second direction 206. The main shaft 66 rotates about the axis A in the second direction 206. By inertia, rotation of the main shaft 66 in the second direction 206 causes the second driving surface 146 of the eccentric bore 86 of the main shaft 66 to engage the second driven surface 186 of the eccentric member 70. Once the second driving surface 146 of the main shaft 66 is engaged with the second driven surface 186 of the eccentric member 70, the center 212 of the tip 94 of the eccentric member 70 is spaced the second eccentric distance 214 from the axis A. The ball bearing eccentric member 78 engaged with the tip 94 of the eccentric member 70 will push the arm of the forked member 82 a second amount corresponding to the second eccentric distance 214, causing the clamping shaft 62 to oscillate with the second degree of oscillation. Thus, the drive mechanism 58 includes an eccentric portion (e.g., the eccentric member 70) having a first amount of eccentricity with respect to the axis A when the main shaft 66 is driven in the first rotational direction and a second amount of eccentricity with respect to the axis A when the main shaft 66 is driven in the second rotational direction.

Thus, the invention provides an eccentric member 70 having a variable eccentricity to effectuate a change in the degree of oscillation of the output shaft (e.g., the hollow spindle 98) of the power tool 10. Changing the direction of rotation of the eccentric member 70 moves the eccentric member 70 to a different position having a different eccentricity. Thus, the invention provides a drive mechanism 58 operatively coupled to drive the output mechanism 60 at a first degree of oscillation when the main shaft 66 is driven in the first rotational direction and operatively coupled to drive the output mechanism 60 at a second degree of oscillation different from the first degree of oscillation when the main shaft 66 is driven in the second rotational direction. Various features and advantages of the disclosure are set forth in the following claims.

What is claimed is:

1. An oscillating power tool comprising:
a main body housing a motor;
a drive mechanism operatively coupled to the motor, the drive mechanism including a shaft that is selectively driven in a first rotational direction and in a second rotational direction opposite the first rotational direction; and
an output mechanism operatively coupled to the drive mechanism, wherein the drive mechanism is configured to convert rotation of the shaft into oscillation of the output mechanism, and
further wherein the drive mechanism is operatively coupled to drive the output mechanism to provide a first degree of oscillation when the shaft is driven in the first rotational direction and operatively coupled to drive the output mechanism to provide a second degree of oscillation when the shaft is driven in the second rotational direction, the second degree of oscillation different from the first degree of oscillation.

2. The oscillating power tool of claim 1, wherein the shaft defines a first axis, and wherein the drive mechanism includes an eccentric member having a first amount of eccentricity with respect to the first axis when the shaft is driven in the first rotational direction and a second amount of eccentricity with respect to the first axis when the shaft is driven in the second rotational direction, wherein the first amount of eccentricity is different from the second amount of eccentricity.

3. The oscillating power tool of claim 2, wherein the eccentric member includes a post at least partially disposed within a bore of the shaft, wherein the eccentric member is movable between a first position having the first amount of eccentricity and a second position having the second amount of eccentricity.

4. The oscillating power tool of claim 3, wherein the eccentric member is rotatable between the first position and the second position.

5. The oscillating power tool of claim 3, wherein the shaft includes a protrusion extending into the bore having a first driving surface and a second driving surface, and the post includes a first driven surface and a second driven surface, and wherein the first driving surface is drivingly engaged with the first driven surface when the shaft is rotated in the first rotational direction and the second driving surface is drivingly engaged with the second driven surface when the shaft is rotated in the second rotational direction.

6. The oscillating power tool of claim 5, wherein a gap is defined between the second driving surface and the second driven surface when the shaft is rotated in the first rotational direction and a gap is defined between the first driving surface and the first driven surface when the shaft is rotated in the second rotational direction.

7. The oscillating power tool of claim 1, further comprising a switch actuatable by a user to effectuate a change between the first rotational direction and the second rotational direction to change the degree of oscillation.

8. The oscillating power tool of claim 1, wherein the motor is reversible to selectively drive the shaft in the first rotational direction or the second rotational direction.

9. The oscillating power tool of claim 1, further comprising a reversing mechanism operatively disposed between the motor and the shaft to selectively change the direction of rotation of the shaft.

10. An oscillating power tool comprising:
a main body housing a motor;
a drive mechanism having a main shaft configured to selectively rotate in a first rotational direction and in a second rotational direction, the main shaft rotatable about a first axis; and
an output mechanism operatively coupled to the drive mechanism, the output mechanism configured to oscillate, wherein the drive mechanism converts rotation of the main shaft into oscillation of the output mechanism;
wherein the drive mechanism includes an eccentric member defining a second axis parallel to and offset from the first axis, the eccentric member movable with respect to the main shaft between a first position having a first offset distance between the second axis and the first axis and a second position having a second offset distance between the second axis and the first axis, wherein the first offset distance is different from the second offset distance, and wherein the first offset distance corresponds to a first degree of oscillation of the output mechanism and the second offset distance corresponds to a second degree of oscillation of the output mechanism, wherein the first degree of oscillation is different from the second degree of oscillation.

11. The oscillating power tool of claim 10, wherein the drive mechanism further includes a forked member operatively coupled between the eccentric member and the output mechanism to convert wobbling of the eccentric member into the oscillation of the output mechanism.

12. The oscillating power tool of claim 10, wherein the eccentric member is rotatable between the first position and the second position.

13. The oscillating power tool of claim 10, wherein the eccentric member includes a post received in the main shaft and an offset tip that is offset from the post.

14. The oscillating power tool of claim 10, wherein the main shaft includes a bore receiving the eccentric member, wherein the bore defines a third axis offset from the first axis, wherein the eccentric member is rotatable within the bore between the first position and the second position, and wherein the eccentric member includes an offset tip centered about the second axis, the offset tip being offset from the third axis.

15. The oscillating power tool of claim 10, wherein the main shaft includes a bore receiving the eccentric member, wherein the main shaft includes a protrusion into the bore, the protrusion having a first driving surface, the eccentric member having a first driven surface, and wherein the first driving surface is engaged with the first driven surface when the main shaft is rotated in the first rotational direction.

16. The oscillating power tool of claim 15, wherein the protrusion further includes a second driving surface and the eccentric member further includes a second driven surface, and wherein the second driving surface is engaged with the second driven surface when the main shaft is rotated in the second direction.

17. The reciprocating power tool of claim 16, wherein the first driving surface is engaged with the first driven surface when the shaft is rotated in the first rotational direction and the second driving surface is engaged with the second driven surface when the shaft is rotated in the second rotational direction.

18. A method of changing the degree of oscillation of an output shaft in a power tool having a motor and a drive mechanism configured to convert rotation of the motor into oscillation of the output shaft, the drive mechanism including a fork for transferring motion from the drive mechanism to the output shaft and a main shaft configured to rotate about a first axis in a first direction and in a second direction opposite the first direction and, the method comprising: providing an eccentric member operatively coupled to the main shaft and to the forked member and having a variable eccentricity to effectuate a change in the degree of oscillation of the output shaft of the power tool.

19. The method of claim 18, further comprising the step of providing the eccentric member defining a second axis offset from the first axis, the eccentric member movable with respect to the main shaft between a first position having a first offset distance between the second axis and the first axis and a second position having a second offset distance between the second axis and the first axis, wherein the first offset distance is different from the second offset distance, wherein the first offset distance corresponds to a first degree of oscillation of the output shaft and the second offset distance corresponds to a second degree of oscillation of the output shaft, and wherein the first degree of oscillation is different from the second degree of oscillation.

20. The method of claim 18, further comprising the step of providing means for changing a direction of rotation of the eccentric member to effectuate a change in the eccentricity of the eccentric member.
